(19) United States
(12) Patent Application Publication
(10) Pub. No.: US 2025/0357528 A1
(43) Pub. Date: Nov. 20, 2025

(54) ELECTROCHEMICAL ENERGY STORAGE DEVICE

(71) Applicant: National Taiwan University of Science and Technology, Taipei (TW)

(72) Inventors: Bing-Joe Hwang, Taipei (TW); Hsuan-Hsuan Su, Taipei (TW); Sheng-Chiang Yang, Taipei (TW); Yu-Chun Huang, Taipei (TW); Wei-Nien Su, Taipei (TW)

(21) Appl. No.: 19/210,334

(22) Filed: May 16, 2025

Related U.S. Application Data
(60) Provisional application No. 63/648,726, filed on May 17, 2024.

(51) Int. Cl. H01M 10/054; H01M 4/525; H01M 4/58; H01M 4/587

(52) U.S. Cl. CPC H01M 10/054; H01M 4/525; H01M 4/5825; H01M 4/587

(57) ABSTRACT

The present invention provides an electrochemical energy storage device comprising: a cathode, which generates a first metal ion that substantially participates in an electrochemical reaction during the operation of the device; an electrolyte, which generates at least one second metal ion that substantially participates in the electrochemical reaction, wherein the second metal ion is different from the first metal ion and has a reduction potential/nucleation charge higher than that of the first metal ion; and an anode that includes at least one current collector foil. The present invention proposes combining two or more heterogeneous metal ions with differing reduction potentials/nucleation charges within the same electrochemical system, utilizing the ion with the lowest reduction potential/nucleation charge to define the reaction window, thereby achieving a novel electrochemical energy storage device involving dual or multiple ion participation.

### FIELD OF INVENTION

The present invention relates to an electrochemical energy storage device, particularly to an electrochemical energy storage device that adopts dual or multiple metal ions to participate in redox reactions, and is applicable to secondary electrochemical devices using metal ions such as lithium, sodium, calcium, magnesium, and aluminum.

The present invention has been developed primarily and secondary to be a Calcium and Sodium battery base on a Lithium battery for describing hereinafter with references and multiple embodiments to this application. However, it will be appreciated that the present invention is not limited to this particular method, field of use or effect.

### BACKGROUND OF THE PRESENT INVENTION

Conventional metal or metal-ion batteries typically utilize a single type of metal ion (such as lithium ion) to undergo redox reactions between the cathode and anode. For instance, in common lithium metal or lithium-ion battery charge-discharge cycles, lithium ions shuttle between the cathode and anode to perform energy storage and release.

In current commercial electrochemical devices, lithium metal and lithium ions are considered ideal ions due to their smallest ionic radius and extremely low reduction potential/nucleation potential (−3.04 V). Lithium ions, as the smallest shuttling metal ions between electrodes, make them the ideal choice for electrochemical devices.

However, the uneven distribution and high cost of lithium resources limit its development and applications. Lithium batteries are still considered too expensive for commercial use because lithium is not an abundantly available element on Earth. Overexploitation could lead to its shortages. Developing batteries based on alternative metals or metal ions is one of the alternative approaches to address this issue. While many studies focus on sodium, potassium, and calcium as alternative ions, challenges remain in terms of battery stability, reaction reversibility, and energy density.

Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE PRESENT INVENTION

In order to solve shortcomings of uneven lithium resource distribution, high costs, and the poor stability and energy performance of alternative metal ion batteries such as sodium, potassium, and calcium, the present invention provides an electrochemical energy storage device comprising a cathode, which generates a first metal ion that substantially participates in an electrochemical reaction during the operation; an electrolyte, which generates at least one second metal ion that substantially participates in the electrochemical reaction, wherein the second metal ion is different from the first metal ion and has a reduction potential/nucleation potential higher than that of the first metal ion; and an anode comprising at least one current collector foil.

In accordance, the present invention has the following advantages:

The present invention enables a novel battery design by combining two or more metal ions with different reduction/nucleation potentials in a single electrochemical device, using the ion with the lowest potential to define the electrochemical window, thereby achieving dual- or multi-ion participation.

The present invention introduces an electrochemical device using dual or multiple metal ion systems, no longer restricted to redox reactions of a single metal ion, thereby breaking the material limitations of traditional lithium-ion batteries. By selecting metal ions with different reduction/nucleation potentials (e.g., lithium and calcium, lithium and sodium), it allows flexible compatibility with existing cathode materials (such as LFP, LiVPO₄F) and inert anode substrates (such as copper or aluminum), avoiding the high cost of developing entirely new materials. Since the behavior of each metal ion within the electrolyte and electrode materials can be independently controlled, the structure offers excellent compatibility and tunability, allowing modular replacement and optimization of ions based on application requirements. This provides broader material selection and design freedom.

Lithium is currently the core material for commercial battery systems. However, it is sparsely distributed in the Earth's crust and concentrated in only a few regions, resulting in high price volatility and supply chain risks. In contrast, metals such as sodium, calcium, magnesium, and aluminum are abundant in the crust, inexpensive to extract, and widely available, contributing to a sustainable and regionally independent material ecosystem. Through the introduction of these alternative metal ions into the Lithium battery systems, the present invention allows anodic deposition and dissolution reactions to occur under operational voltages, effectively replacing the core function of lithium-based systems and meeting the urgent demand for low-cost, stable-supply materials during the energy transition. It also enhances the battery industry's geographic diversity and economic resilience.

Enhanced battery capacity and diversified reaction mechanism design potential: The operation of a dual-metal-ion or multi-metal-ion system allows multiple redox reactions to occur either simultaneously or sequentially. For example, in a calcium-lithium system, lithium undergoes intercalation/deintercalation at the cathode, while calcium undergoes metal plating/stripping at the anode, forming a dual-electrode, functionally divided energy storage mode. This mechanism not only increases the overall capacity density and reaction efficiency of the battery but also expands the reaction window, reduces polarization and energy loss, and improves cycle stability. Furthermore, the present invention has the potential to introduce tertiary or higher-order ion participants, enabling the development of novel multi-potential-platform energy storage systems that achieve intelligent layered power supply or segmented energy management, thereby expanding the application potential in high-power energy storage, electric vehicles, and renewable energy integration.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a schematic diagram of the electrochemical energy storage device in accordance to the present invention;

FIG. 2 is a schematic diagram of the first preferred embodiment of the electrochemical energy storage device in accordance to the present invention;

FIG. 3 is a schematic diagram of the second preferred embodiment of the electrochemical energy storage device in accordance to the present invention;

FIG. 4 is a schematic diagram of a comparative example lithium battery without an anode;

FIG. 5 shows the X-ray Photoelectron Spectroscopy (XPS) analysis of the first preferred embodiment in accordance to the present invention;

FIGS. 6A and 6B compare the electrochemical performance of a comparative example and the first preferred embodiment in accordance to the present invention;

FIG. 7 shows the Scanning Electron Microscope (SEM) analysis of the first preferred embodiment in accordance to the present invention; and

FIGS. 8A and 8B show the Energy Dispersive X-ray Spectroscopy (EDS) analysis of the current collector after first charging in the second embodiment in accordance to the present invention.

### DETAILED DESCRIPTION OF THE PREFERRED EMBODIMENTS

Reference will now be made in detail to the present preferred embodiments of the present invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

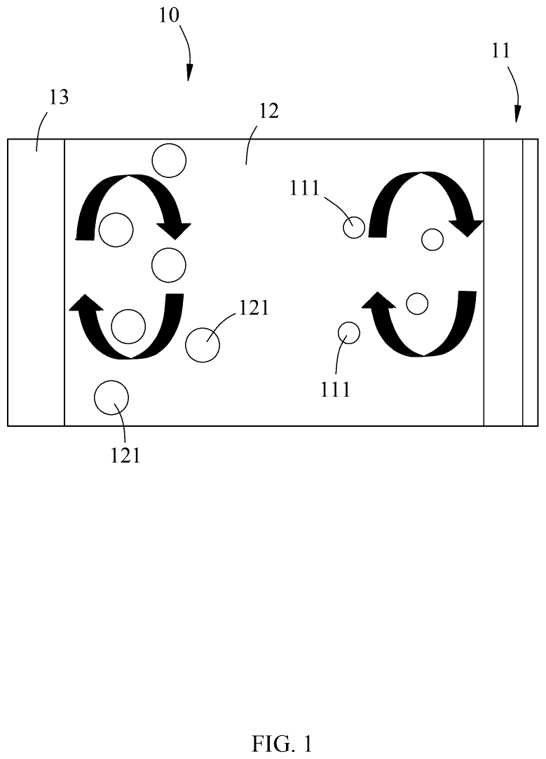

Please refer to FIG. 1, which illustrates a preferred embodiment of the electrochemical energy storage device 10 of the present invention. It comprises:
a cathode 11, which, during the electrochemical reaction, generates a first metal ion 111 that substantially participates in the electrochemical reaction;
an electrolyte 12, which, during the electrochemical reaction, generates at least one second metal ion 121 that substantially participates in the electrochemical reaction, wherein the second metal ion 121 is different from the first metal ion 111 and has a reduction potential/nucleation potential higher than that of the first metal ion 111; and
an anode 13, which includes at least one current collector foil to allow the second metal ion 121 to intercalate and deintercalate during participation in the electrochemical reaction.

The first metal ion 111 or the second metal ion 121 may include lithium (Li), sodium (Na), calcium (Ca), potassium (K), magnesium (Mg), barium (Ba), strontium (Sr), aluminum (Al), zinc (Zn), nickel (Ni), or iron (Fe).

Preferably, the electrolyte 12, in addition to the second metal ion 121, may further include a third metal ion, a fourth metal ion, a fifth, a sixth, or one or more other metal ions. As long as the metal ions generated by the electrolyte during the electrochemical reaction substantially participate in the electrochemical reaction and have a reduction potential/nucleation potential higher than that of the first metal ion 111 in the cathode 11, such ions are considered within the scope of the present invention. In another preferred embodiment of the present invention, the electrolyte 12 may also generate the first metal ion 111 that substantially participates in the electrochemical reaction during the electrochemical process by controlling the operation voltage or potential.

The electrode foil of the cathode 11 and the anode 13 includes copper foil, aluminum foil, or stainless steel foil. Preferably, depending on the type of electrochemical device, the cathode 11 and the anode 13 in the present invention may include or may not include a positive electrode material or a negative electrode material. In some preferred embodiments, if the negative electrode material is not included, the battery is an anode-free battery. The positive electrode materials applicable to the present invention include, but are not limited to, lithium manganese oxide, lithium iron phosphate, lithium nickel cobalt manganese oxide, lithium cobalt oxide, and other ternary materials, as well as all commonly available commercial positive electrode materials. The negative electrode materials include, but are not limited to, all commonly available carbon-based or non-carbon-based negative electrode materials.

The electrochemical energy storage device 10 provided by the present invention controls the charge/discharge voltage or potential range such that the electrochemical reactions occur within a window lower than the reduction potential of the first metal ion 111 and higher than the reduction potential of the second metal ion 121. In this configuration or operation arrangement, the electrochemical behavior is primarily dominated by the second metal ion 121. In other preferred embodiments of the present invention, the electrochemical energy storage device 10 controls the charge/discharge voltage or potential range such that the reaction occurs at the reduction potential of the first metal ion 111, enabling the electrochemical energy storage device 10 to exhibit combined electrochemical behavior of both the first metal ion 111 and the second metal ion 121.

Please refer to Table 1 below, which presents the electrochemical reaction equations and the corresponding reduction/nucleation potentials of the first metal ion 111 or the second metal ion 121 that substantially participate in the electrochemical reaction. It should be noted that the reduction/nucleation potentials listed below are expressed as negative values. Accordingly, the more negative the value, the lower the reduction/nucleation potential. For example, a reduction/nucleation potential of −2.71 V is higher than that of −3.04 V.

TABLE 1

| | Electrochemical | Reduction/Nucleation | |
|---|---|---|---|
| Metal Type | Reaction Equation | Potential (E⁰) | |
| Lithium (Li) | Li⁺ + e⁻ [symbol] Li(s) | −3.04 | V |
| Sodium (Na) | Na⁺ + e⁻ [symbol] Na(s) | −2.71 | V |
| Calcium (Ca) | Ca²⁺ + 2e⁻ [symbol] Ca(s) | −2.87 | V |
| Potassium (K) | K⁺ + e⁻ [symbol] K(s) | −2.92 | V |
| Magnesium (Mg) | Mg²⁺ + 2e⁻ [symbol] Mg(s) | −2.93 | V |
| Barium (Ba) | Ba²⁺ + 2e⁻ [symbol] Ba(s) | −2.912 | V |
| Strontium (Sr) | Sr²⁺ + 2e⁻ [symbol] Sr(s) | −2.912 | V |
| Aluminum (Al) | Al³⁺ + 3e⁻ [symbol] Al(s) | −1.66 | V |
| Zinc (Zn) | Zn²⁺ + 2e⁻ [symbol] Zn(s) | −0.7618 | V |
| Nickel (Ni) | Ni²⁺ + 2e⁻ [symbol] Ni(s) | −0.25 | V |
| Iron (Fe) | Fe³⁺ + 3e⁻ [symbol] Fe(s) | −0.04 | V |

### Embodiment 1

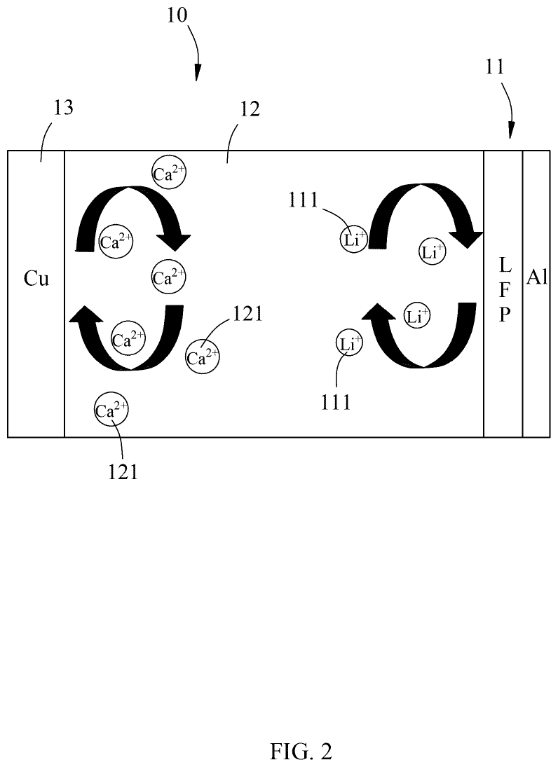

Please refer to FIG. 2. The first embodiment of the present invention is a calcium battery based on a lithium battery framework. Lithium iron phosphate (LFP) is used as the cathode material, calcium perchlorate (Ca(ClO₄)₂) is added to the electrolyte as the calcium ion source, and the anode is a copper substrate.

In this embodiment, calcium ions are introduced as the second metal ion 121, having a higher reduction potential/nucleation potential than lithium ions. The calcium ions are incorporated into the system via the electrolyte. By operating the system based on the reduction/nucleation potential of calcium ions, the present invention successfully enables a calcium-based battery even in the presence of lithium ions. This embodiment starts from an anode-free lithium battery using LFP as the cathode and is transformed into a calcium-based rechargeable system simply by introducing a calcium-based electrolyte. The calcium ions are provided by calcium salts in the electrolyte, while the lithium ions may come from either lithium salts or lithium-containing cathode materials.

In this embodiment, the reduction/nucleation potential of lithium ions is −3.04 V, and that of calcium ions is higher, at −2.87 V. Meanwhile, lithium ions also serve to maintain the electrochemical neutrality of the overall system. When the device operates under the reduction/nucleation potential of calcium, calcium ions are deposited onto the anode during the charging process, forming a calcium-metal battery. Specifically, by applying −2.87 V, Ca²⁺ ions begin to undergo electrochemical deposition at the anode side, thereby converting the lithium-ion-based system into a calcium-ion system. During discharge, the calcium metal at the anode dissolves back into calcium ions, while the lithium ions return to the cathode, thereby forming a dual-metal-ion (calcium-lithium) battery system built on a lithium battery framework but exhibiting heteroionic electrochemical characteristics.

### Embodiment 2

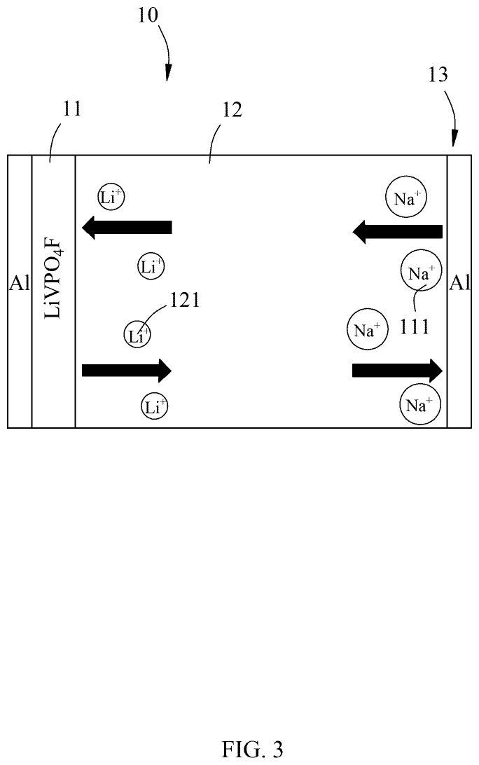

Please refer to FIG. 3. The second preferred embodiment of the present invention is also a calcium battery based on a lithium battery framework, implemented as a coin cell. LiVPO₄F is used as the positive electrode material, aluminum foil as the anode current collector, C2325 as the separator, and 1 M NaPF₆ in EC (1:1) as the electrolyte. During charging, sodium ions are reduced to metallic sodium on the aluminum foil, and lithium ions are deintercalated from the cathode into the electrolyte, with possible deposition on the sodium.

For this embodiment, the preferred cathode electrode is prepared using LiVPO₄F:Super P:PVDF in a weight ratio of 8:1:1, with NMP as the solvent. The theoretical capacity is 156 mAh/g. The electrode has a thickness of 65 μm and contains 2.8 mg of active material. The voltage range is 3.2-4.5 V. The cathode performance is first verified using a lithium-based electrolyte and then evaluated with a sodium-based electrolyte. The capacity of the sodium electrolyte is calculated assuming complete dissociation, with a theoretical capacity of 159 mAh/g. Given 60 μL=0.007 g, the total electrolyte capacity is 1.113 mAh, and the electrode capacity is calculated as 156×0.00288=0.4449 mAh.

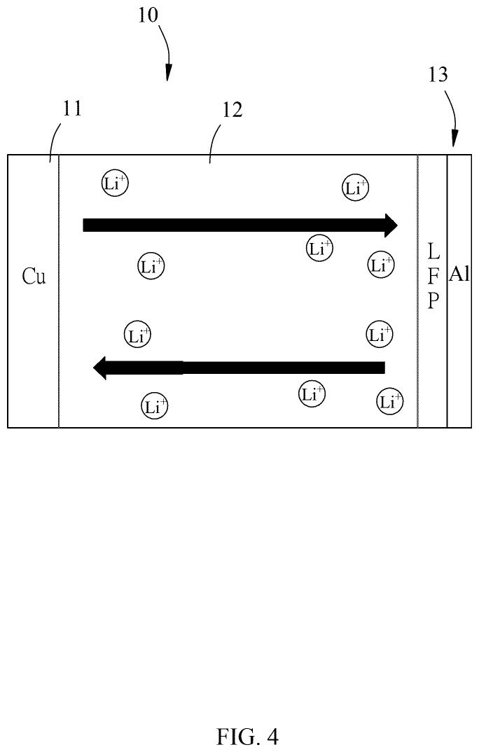

Please refer to FIG. 4, which shows a schematic diagram of a comparative embodiment: a conventional anode-free lithium battery.

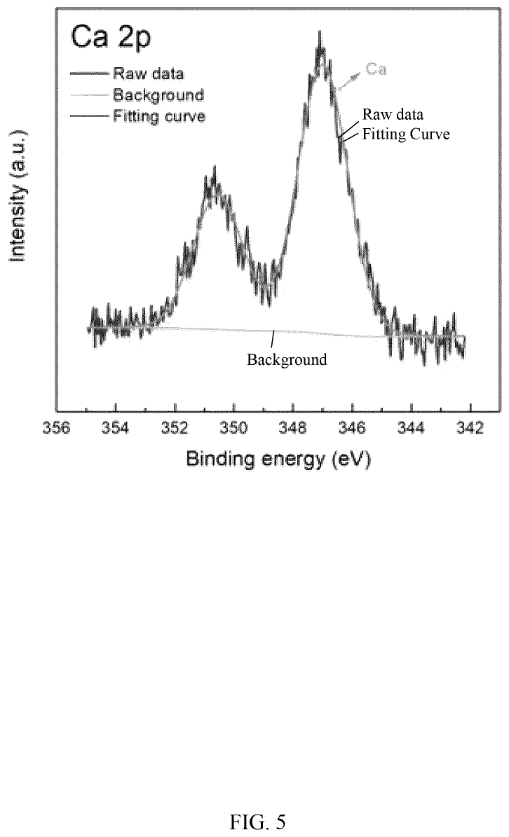

Please refer to FIG. 5, which presents the X-ray Photoelectron Spectroscopy (XPS) analysis of the first preferred embodiment. Calcium ion deposition is observed on the anode side, indicating that the present invention successfully converts a lithium-based battery into a calcium-based system.

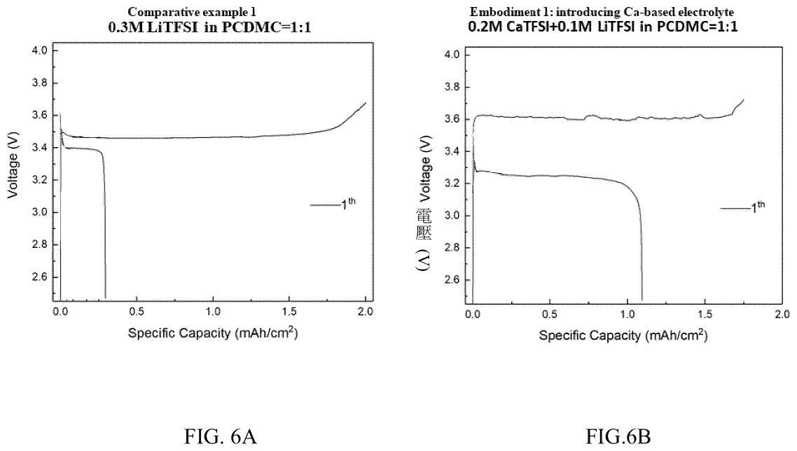

FIGS. 6A and 6B compare the electrochemical performance of the comparative embodiment and the first preferred embodiment. The embodiment shows a higher specific discharge capacity, confirming calcium ion deposition and demonstrating that the system exhibits enhanced capacitive characteristics as a calcium-based battery.

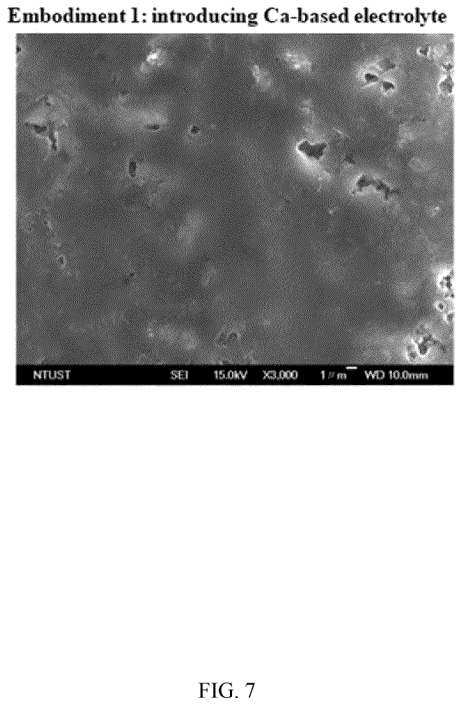

FIG. 7 shows the Scanning Electron Microscope (SEM) analysis of the first preferred embodiment. The results reveal metallic calcium deposited on the anode, confirming that the present invention indeed successfully realizes a calcium battery based on a lithium battery framework.

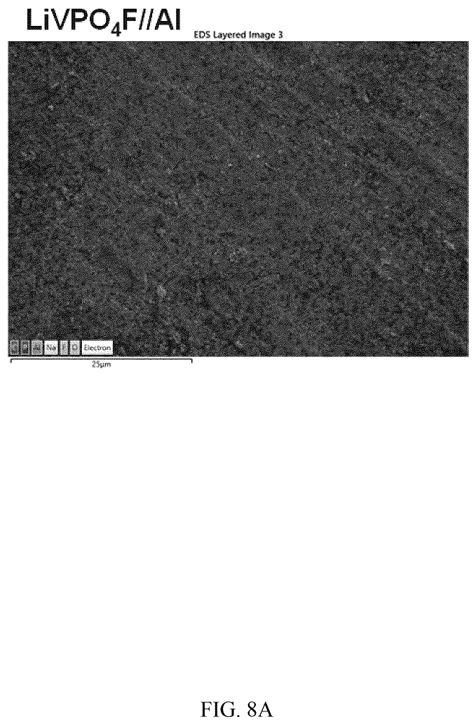

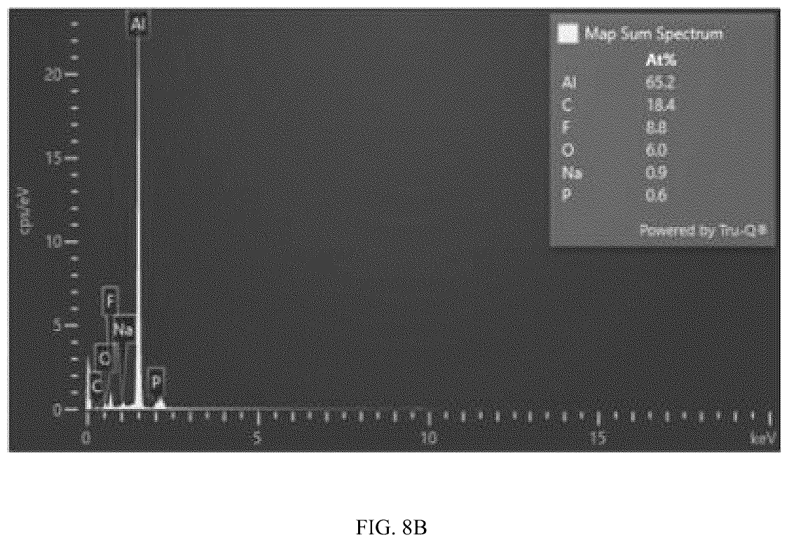

FIGS. 8A and 8B present the Energy Dispersive X-ray Spectroscopy (EDS) analysis of the current collector after the first charging cycle in the second embodiment. The results confirm the presence of sodium deposition and the detection of Na element signals on the surface of the current collector. This embodiment represents a dual-metal-ion system that effectively combines the electrochemical advantages of both lithium and sodium, making it suitable for high-capacity and high-power-density energy storage applications.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. An electrochemical energy storage device, comprising:
a cathode, which generates a first metal ion that substantially participates in an electrochemical reaction during the operation;
an electrolyte, which generates at least one second metal ion that substantially participates in the electrochemical reaction, wherein the second metal ion is different from the first metal ion and has a reduction potential/nucleation potential higher than that of the first metal ion; and
an anode comprising at least one current collector foil.

2. The electrochemical energy storage device of claim 1, wherein the electrolyte also generates the first metal ion that substantially participates in the electrochemical reaction.

3. The electrochemical energy storage device of claim 1, wherein the first metal ion or the second metal ion comprises lithium (Li), sodium (Na), calcium (Ca), potassium (K), magnesium (Mg), barium (Ba), strontium (Sr), aluminum (Al), zinc (Zn), nickel (Ni), or iron (Fe).

4. The electrochemical energy storage device of claim 1, wherein the electrolyte further comprises one or more heterogeneous metal ions in addition to the second metal ion, each having a reduction potential/nucleation potential higher than that of the first metal ion.

5. The electrochemical energy storage device of claim 2, wherein the electrolyte further comprises one or more heterogeneous metal ions in addition to the second metal ion, each having a reduction potential/nucleation potential higher than that of the first metal ion.

6. The electrochemical energy storage device of claim 1, wherein the current collector foil of the anode comprises copper foil, aluminum foil, or stainless steel foil.

7. The electrochemical energy storage device of claim 2, wherein the current collector foil of the anode comprises copper foil, aluminum foil, or stainless steel foil.

8. The electrochemical energy storage device of claim 1, wherein the charge/discharge voltage or potential of the device is controlled to be lower than the reduction potential of the first metal ion and higher than that of the second metal ion, or equal to the reduction potential of the first metal ion.

9. The electrochemical energy storage device of claim 2, wherein the charge/discharge voltage or potential of the device is controlled to be lower than the reduction potential of the first metal ion and higher than that of the second metal ion, or equal to the reduction potential of the first metal ion.

10. The electrochemical energy storage device of claim 1, wherein the cathode comprises a positive electrode material selected from lithium manganese oxide, lithium iron phosphate, lithium nickel cobalt manganese oxide, or lithium cobalt oxide.

11. The electrochemical energy storage device of claim 2, wherein the cathode comprises a positive electrode material selected from lithium manganese oxide, lithium iron phosphate, lithium nickel cobalt manganese oxide, or lithium cobalt oxide.

12. The electrochemical energy storage device of claim 1, wherein the anode comprises a negative electrode material selected from carbon-based or non-carbon-based negative electrode materials.

13. The electrochemical energy storage device of claim 2, wherein the anode comprises a negative electrode material selected from carbon-based or non-carbon-based negative electrode materials.
